(19) United States
(12) Patent Application Publication
(10) Pub. No.: US 2012/0047064 A1
(43) Pub. Date: Feb. 23, 2012

(54) METHODS AND SYSTEMS FOR ONLINE CREDIT OFFERS

(76) Inventor: D. Loudoun EMSWILER, Charlotte, NC (US)

(21) Appl. No.: 13/288,533

(22) Filed: Nov. 3, 2011

Related U.S. Application Data
(63) Continuation of application No. 12/615,922, filed on Nov. 10, 2009, now abandoned.
(60) Provisional application No. 61/112,857, filed on Nov. 10, 2008.

(51) Int. Cl. G06Q 40/02

(52) U.S. Cl. 705/38

(57) ABSTRACT

Provided are methods and systems for coordinating a loan between a lender and a borrower. The methods and systems can provide enhanced offers by way of a Best Offer Strategy and Standardized Presentation of offers to borrowers. Also provided is a computerized business-to-business operations management system (a “portal”) centered around business performance analytics, wherein the selection criteria and business rules used to connect borrowers to lenders can be refined based upon the business performance analytics.

### CROSS-REFERENCE TO RELATED APPLICATIONS

This application is a continuation of and claims the benefit of U.S. Ser. No. 12/615,922, filed Nov. 10, 2009, which claims the benefit of U.S. Ser. No. 61/112,857, filed Nov. 10, 2008, which application is hereby fully incorporated herein by reference.

### FIELD

Embodiments of the invention relate, generally, to online credit offers and, in particular, to techniques for coordinating borrowers with lenders and providing aggregated and standardized best offers.

### SUMMARY

In general, embodiments of the present invention provide methods and systems for coordinating a credit offer (e.g., a loan) between a lender and a borrower. The methods and systems of embodiments described herein can provide enhanced offers by way of a Best Offer Strategy and Standardized Presentation of offers to borrowers. Also provided is a computerized business-to-business operations management system (a “portal”) centered around business performance analytics, wherein the selection criteria and business rules used to connect borrowers to lenders can be refined based upon the business performance analytics.

According to one aspect a method is provided for coordinating a credit offer between a lender and a borrower. In one embodiment, the method may include: (1) receiving a credit application associated with a borrower; (2) retrieving, from a database, a set of selection criteria associated with each of a plurality of lenders; (3) comparing, by a computing device executing a matching module, the credit application received to the plurality of sets of selection criteria in order to identify one or more matched lenders; (4) transmitting the credit application to at least one of the one or more matched lenders; and (5) receiving, by the computing device from the at least one of the one or more matched lenders, one or more offers to provide to the borrower in association with the at least one matched lender, wherein the one or more offers were identified by applying a set of business rules associated with the at least one matched lender to the credit application.

In one embodiment, the method may further include providing, by the computing device, a web-based platform through which respective lenders of the plurality of lenders can view and filter information associated with one or more offers made and one or more offers accepted in association with the corresponding lender and/or in association with other lenders of the plurality of lenders (i.e., competitors). The method of this embodiment may further include a lender making modifications to one or more of the business rules associated with the lender based on the lender's review of information via the web-based platform.

In yet another embodiment, the method may further include aggregating, by the computing device, the one or more offers received in association with the at least one matched lender in a standardized format and presenting the aggregated and standardized offers to the borrower.

According to another aspect a network device is provided for coordinating a credit offer between a lender and a borrower. In one embodiment, the network device may include a processor configured to: (1) receive a credit application associated with a borrower; (2) retrieve, from a database, a set of selection criteria associated with each of a plurality of lenders; (3) compare the credit application received to the plurality of sets of selection criteria in order to identify one or more matched lenders; (4) transmit the credit application to at least one of the one or more matched lenders; and (5) receive, from the at least one of the one or more matched lenders, one or more offers to provide to the borrower in association with the at least one matched lender, wherein the one or more offers were identified by applying a set of business rules associated with the at least one matched lender to the credit application.

According to yet another aspect a computer program product is provided for coordinating a credit offer between a lender and a borrower. The computer program product contains at least one computer-readable storage medium having computer-readable program code portions stored therein. The computer-readable program code portions of one embodiment include: (1) a first executable portion for receiving a credit application associated with a borrower; (2) a second executable portion for retrieving, from a database, a set of selection criteria associated with each of a plurality of lenders; (3) a third executable portion for comparing the credit application received to the plurality of sets of selection criteria in order to identify one or more matched lenders; (4) a fourth executable portion for transmitting the credit application to at least one of the one or more matched lenders; and (5) a fifth executable portion for receiving, from the at least one of the one or more matched lenders, one or more offers to provide to the borrower in association with the at least one matched lender, wherein the one or more offers were identified by applying a set of business rules associated with the at least one matched lender to the credit application.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of one type of system that would benefit from embodiments of the present invention;

FIG. 2 is an exemplary operating environment in accordance with embodiments described herein; and

FIG. 3 illustrates a process for coordinating borrowers with lenders in accordance with an embodiment of the present invention.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

### Overall System and Loan Facilitator Server

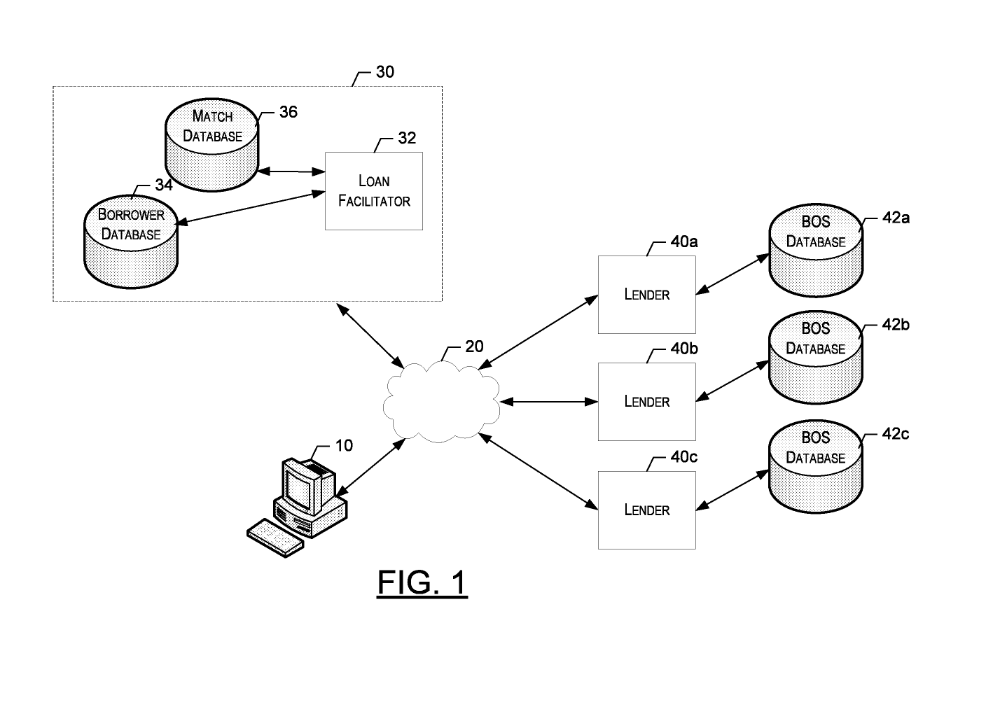

Referring to FIG. 1, a system for coordinating credit offers (e.g., loans) between a borrower and one or more lending institutions is provided. As used herein, a lending institution (referred to hereinafter as “lender”) can be any private, public, or institutional entity which makes funds available to others to borrow. As shown in FIG. 1, the system can include an electronic device 10 (e.g., personal computer (PC), laptop, personal digital assistant (PDA), etc.) operated by a borrower for the purpose of submitting a credit application and receiving one or more credit offers from one or more lenders. As described in more detail below, according to one embodiment, the borrower can submit the credit application and receive the credit offers via a website operated by a Loan Facilitator system 30.

In particular, as shown in FIG. 1, the system of embodiments described herein can further include a Loan Facilitator system 30 in communication with the borrower device 10 over a communication network 20 (e.g., the Internet). In one embodiment, the Loan Facilitator system 30 can be configured, as described in more detail below, to receive the credit application and to provide the borrower with one or more “best” offers from one or more matched lenders, wherein the offers have been aggregated into a standardized and comparable format. In order to provide the borrower with the aggregated and standardized “best” offers, the Loan Facilitator system 30 can include a Loan Facilitator server 32, or similar network entity, as well as one or more databases 34 and 36. As shown, these databases may include, for example, a borrower database 34 and/or a match database 36. In one embodiment, the borrower database 34 can store credit application data and credit score information associated with each of a plurality of borrowers, and the match database 36 can store a set of selection criteria associated with each of a plurality of lenders that can be used by the Loan Facilitator server 32 to match borrowers to lenders.

As described in more detail below, in addition to operating the website through which a borrower can submit a credit application and receive one or more credit offers, the Loan Facilitator system 30 can further provide a web-based platform, or portal, configured to support business operations between one or more lenders and the Loan Facilitator system 30 and to facilitate business performance analytics.

Finally, the system of embodiments of the present invention can further include one or more servers, or similar network entities, associated with a corresponding one or more lenders 40a, 40b, 40c, also in communication with the Loan Facilitator system 30 over the same or different communication network 20. As described in more detail below. The lender servers 40a, 40b, 40c, may be in communication with the Loan Facilitator system 30 in order to, for example, provide and/or update selection criteria to be used for matching borrowers to lenders, to provide one or more “best” offers to be presented to a borrower in response to being matched to that borrower, and to perform business analytics, which is discussed in more detail below. In order to provide one or more “best” offers for a borrower, according to one embodiment, each lender may store (e.g., in one or more databases 42a, b, c) and update a set of business rules to be used for identifying and selecting the “best” offers. As discussed below, the business rules may be updated based on feedback received in association with offers made and/or accepted by the lender and/or one or more of its competitors, as viewed via the portal provided by the Loan Facilitator system 30.

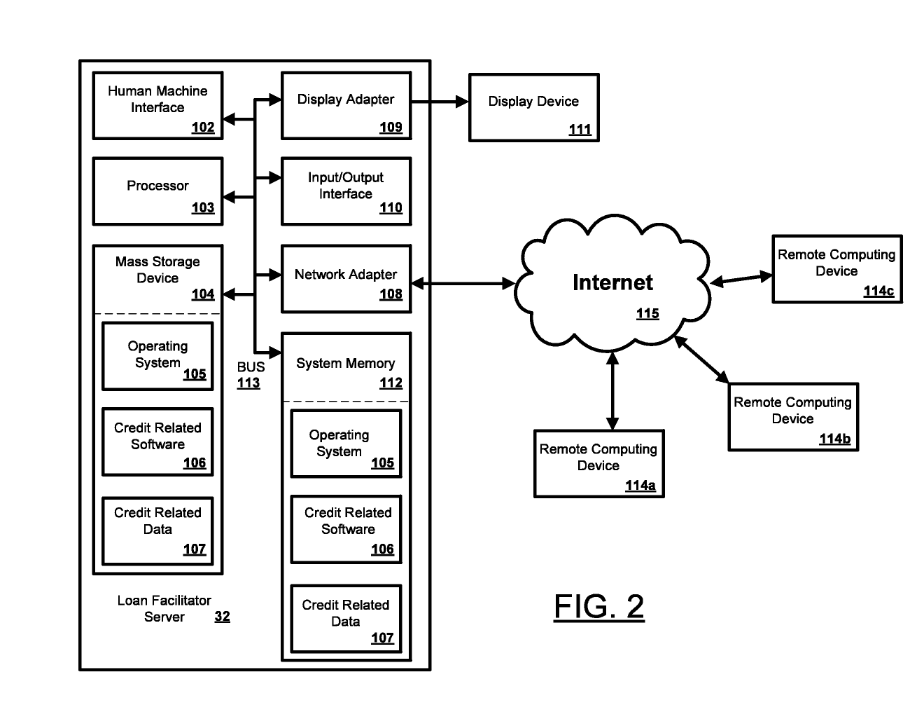

While the foregoing describes separate databases 34, 36, 42a, b, and c as being associated with and containing information used by the Loan Facilitator system 30 and lender servers 40a, b, c, respectively, as one of ordinary skill in the art will recognize in light of this disclosure, the contents of these databases can be stored in a single database or spread over any number of databases. Alternatively, or in addition, as discussed below with regard to FIG. 2, some or all of the information described as being stored in the databases may be stored locally on the Loan Facilitator server 32 and/or one or more of the lender servers 40a, b, c.

In addition, while the foregoing refers to a Loan Facilitator “server” and lender “servers,” as one of ordinary skill in the art will recognize in light of this disclosure, embodiments of the present invention are not limited to a client-server architecture. In contrast, other similar computing devices and architectures may likewise be used without departing from the spirit and scope of embodiments described herein.

Reference is now made to FIG. 2 which illustrates an exemplary operating environment associated with the Loan Facilitator system 30 of embodiments described herein. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable Borrower electronics, network PCs, minicomputers, mainframe computers, distributed computing environments that comprise any of the above systems or devices, and the like.

The processing of the disclosed methods and systems can be performed by software components. The disclosed Loan Facilitator system 30 and corresponding method can be described in the general context of computer-executable instructions, such as program modules (e.g., a matching module and/or an aggregation module, discussed below), being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the functionality of the Loan Facilitator system 30 disclosed herein can be implemented via a general-purpose computing device in the form of a server 32, or similar network entity. The components of the Loan Facilitator server 32 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, credit related software 106, credit related data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The Loan Facilitator server 32 typically comprises a variety of computer readable media. Exemplary readable media can be any available media that is accessible by the server 32 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as credit related data 107 and/or program modules such as operating system 105 and credit related software 106 that are immediately accessible to and/or are presently operated on by the processing unit 103.

In one embodiment, the credit related data 107 can include the information described above with reference to FIG. 1 as being stored in either or both the borrower database 34 or the match database 36. In particular, the credit related data 107 can include credit application data and/or credit scores associated with one or more borrowers, and/or one or more sets of selection criteria that can be used to match borrowers to lenders.

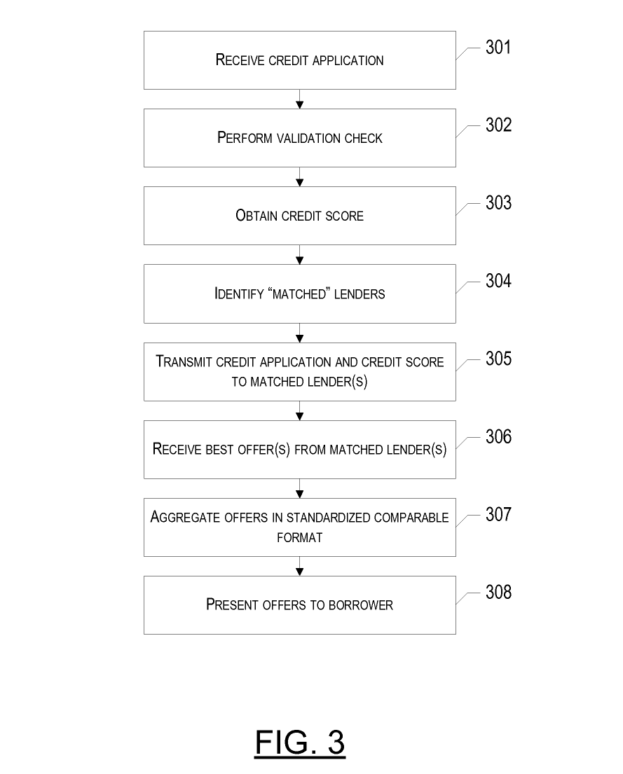

Similarly, the credit related software 106 can include one or more software modules configured to cause the processing unit 103 to perform the functionality described below with reference to FIG. 3. In particular, the credit related software 106 can include a matching module and/or an aggregation module. As described in more detail below, in one embodiment, the matching module can be configured to cause the processing unit 103 to compare credit application data and/or credit score information associated with a borrower to one or more sets of selection criteria associated with a corresponding one or more lenders in order to match the borrower to one or more lenders. The aggregation module may then be configured to cause the processing unit 103 to aggregate and standardize one or more “best” offers received from respective matched lenders prior to presenting the offers to the borrower.

In another aspect, the Loan Facilitator server 32 can also comprise other removable/non-removable, volatile/non-volatile computer storage media. By way of example, FIG. 2 illustrates a mass storage device 104 which can provide non-volatile storage of computer code, computer readable instructions, data structures, program modules, and other data for the Loan Facilitator server 32. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and credit related software 106 (e.g., matching and/or aggregation module). Each of the operating system 105 and credit related software 106 (or some combination thereof) can comprise elements of the programming and the credit related software 106. Credit related data 107 (e.g., borrower information, and/or selection criteria) can also be stored on the mass storage device 104. Credit related data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the Loan Facilitator server 32 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the Loan Facilitator server 32 can have more than one display adapter 109 and the Loan Facilitator server 32 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the Loan Facilitator server 32 via Input/Output Interface 110. Any step and/or result of the methods can be output in any form to an output device. Such output can be any form of visual representation, including, but not limited to, textual, graphical, animation, audio, tactile, and the like.

The Loan Facilitator server 32 can operate in a networked environment using logical connections to one or more remote computing devices 114a, b, c. By way of example, a remote computing device can be a personal computer, portable computer, a server, a router, a network computer, a peer device or other common network node, and so on. Logical connections between the Loan Facilitator server 32 and a remote computing device 114a, b, c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115. In an aspect, a loan processing computer can coordinate one or more loan applications between lending institution computers and borrower computers. The coordination can be through the Internet via a web browser such as Netscape or Internet Explorer.

In an aspect, various communication techniques can be used to communicate with borrowers, lenders, and between borrowers and lenders. In an aspect, email is utilized for all communications between the system provided, borrowers, and lenders. In another aspect, Common Gateway Interface (CGI), Active File Transfer (AFTS), as a secured file on a secured webpage (S.W.) communication techniques can be used. In another aspect, a lender can specify a preferred communication technique.

For purposes of illustration, application programs and other executable program components such as the operating system 105 are illustrated herein as discrete blocks, although it is recognized that such programs and components reside at various times in different storage components of the Loan Facilitator server 32, and are executed by the data processor(s) of the server. An implementation of credit related software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

### Method of Coordinating Borrowers and Lenders

Referring now to FIG. 3, a process for coordinating loans between lending institutions and borrowers through a network such as the Internet is provided. In particular, according to one embodiment, provided are methods and systems for coordinating an electronic credit application between a prospective borrower and one or more lenders. For example, as shown in FIG. 3, the process may begin when a borrower uses his or her electronic device 10 (e.g., personal computer (PC), laptop, personal digital assistant (PDA), etc.) to access a website operated by the Loan Facilitator system 30 in order to submit a credit application, which is received by the Loan Facilitator system 30 (e.g., the Loan Facilitator server 32) at Block 301. According to one embodiment, the credit application may include information (referred to as “credit application data”) sufficient for a lender to make a credit determination. For example, the borrower can submit information such as, name, date of birth, social security number, employer, income, mortgage property address, marital status, and/or the like.

Upon receipt, according to one embodiment, the Loan Facilitator system 30 (e.g., the Loan Facilitator server 32 and, in particular a processor executing thereon) can perform a validation check to ensure that the application is complete and correct. (Block 302). In addition, the Loan Facilitator server 32 (e.g., a processor executing thereon) can retrieve a credit score (such as a FICO or VantageScore) and associate the retrieved credit score with the credit application data. (Block 303). In particular, according to one embodiment, the Loan Facilitator server 32 can store the credit application data received and the retrieved credit score in the borrower database 34 in association with the borrower.

According to one embodiment, the Loan Facilitator server 32 and, in particular, a processor associated with the Loan Facilitator server 32 executing, for example, the matching module, can, at Block 304, compare the credit application data and credit score to one or more sets of selection criteria provided by one or more lenders in order to identify one or more “matched” lender(s). As noted above, according to one embodiment, the selection criteria associated with each of a plurality of lenders may be stored in a database 36 associated with and accessible by the Loan Facilitator server 32.

Examples of selection criteria can include, but are not limited to, requested loan amount, credit score, property location, property size, requested loan type, down payment amount, dwelling unit type, current home value, available equity, monthly payment, mortgage amount, loan type (VA, FHA, conventional), loan-to-value, requested interest rate, purchase price, rate type (fixed, variable), sale date, sale type (new, resale), length of residence, telephone number, marital status, gender, age, income, presence of children, ethnicity, demographic selects, and the like. According to one embodiment, there can be zero, one, or a plurality of lenders matched to a borrower's credit application.

Once one or more matched lenders have been identified, according to one embodiment of the present invention, the Loan Facilitator system 30 can, at Block 305, transmit the credit application data and, where applicable, credit score to one or more of the matched lenders for further processing. In particular, according to one embodiment, upon receipt of the credit application data and credit score, the matched lender may, either itself (i.e., a processor executing on the matched lender server) or via a third party, utilize a “Best Offer Strategy” to identify one or more offers to provide the borrower. According to embodiments described herein, the Best Offer Strategy can be defined as a lender's ability to establish, and refine as needed, business rules for providing offers to borrowers. The business rules can be related to credit application data, loan products, loan rates, and/or loan product selection criteria. As noted above, the business rules can be stored in association with the corresponding lender within a best offer strategy (BOS) database 42a, b, c.

In order to identify one or more offers, according to one embodiment, the lender server 32 (e.g., a processor executing on the lender server), or associated third party, can retrieve and apply the business rules associated with the matched lender to the credit application data and credit score associated with the borrower in order to identify and select the loan products that can be offered to the borrower in association with that lender.

According to embodiments of the present invention, the business rules used in the Best Offer Strategy allow for adjustment of logic to select products that are “best” for lenders in terms of potential profit margin, and logic to select products that are “best” for borrowers in terms of borrowers' eligibility and financial wherewithal to make the projected loan payments. For example, the following are business rules that may be applied in accordance with an embodiment of the present invention: (1) For all borrowers within a certain credit range or ranges, increase or reduce the profit margin included in the quoted interest rate; (2) For all borrowers within a certain credit range or ranges, include only FHA products in the offers.

As discussed in more detail below, the business rules can further ensure that the products that are presented to borrowers are in accordance with a standardized format. In addition, a performance analytics component, also described below, can be used to create a feedback loop to automatically modify the business rules to adjust for the lender's lending performance.

Once the matched lender has identified one or more “best” offers to provide to the borrower, the lender (i.e., a processor executing on the lender server) may transmit the offer(s) to the Loan Facilitator server 32, which may receive the offer(s) at Block 306.

According to another embodiment, not shown, the Loan Facilitator server 32, and not the various lender servers, may itself perform the BOS in order to identify one or more “best” offers to present to a borrower in association with respective matched lenders. In this embodiment, the Loan Facilitator system 30 may further include a BOS database (not shown) in which a set of business rules may be stored in association with each of the plurality of lenders. In order to identify the “best” offers, the Loan Facilitator server 32 may retrieve and apply the business rules associated with each of the matched lenders to the borrower's credit application data and credit score.

Returning to FIG. 3, once one or more “best” offers have been received in association with respective matched lenders, the Loan Facilitator server 32 (e.g., a processor associated with the Loan Facilitator server 32 and executing an aggregation module) can aggregate the selected offers in a standardized comparable format and present those offers to the borrower. (Blocks 307 and 308).

According to one embodiment, only preliminary loan offer information may be provided to a borrower based upon the initial matching of the credit application and the set of selection criteria provided by the lender. In another embodiment, loan offer information that a lender agrees to be bound to can be provided based upon the initial matching of the credit application and the set of selection criteria provided by the lender (for example, if the credit application includes a credit score). In yet another embodiment, loan offer information (preliminary and/or binding) can be provided to a borrower only after credit application review by the lender.

According to one embodiment, the loan offer information can be presented to the borrower through the website utilized to submit the credit application (i.e., the website operated by the Loan Facilitator system 30). According to one embodiment, the offer information provided to the user via the website may be formatted into a standard format such that the borrower can more easily compare offers received from different lenders. In order to standardize the offers provided, according to one embodiment, lenders may be required to provide loan offer data to the Loan Facilitator system 30 that meet one or more Offer Standards. The following provides a few examples of Offer Standards that may be applied. As one of ordinary skill in the art will recognize in light of this disclosure, any one or more of the following standards may be applied in combination with one another. As one of ordinary skill in the art will further recognize in light of this disclosure, the following examples are provided for exemplary purposes only and should not be taken in any way as limiting embodiments of the present invention to the examples provided.

Standard #1: Lenders may be required to always submit at least one offer matching a loan program requested by the borrower. The goal of this standard is to ensure that borrowers receive offers that match what they originally requested.

Standard #2: Lenders' offers to borrowers may be required to be accurate, which means that: (1) lenders' calculations and disclosures for the data (e.g. APR, variable rate, payment amounts) displayed to borrowers in offers will comply with applicable laws including, but not limited to, Regulation Z; (2) lenders offers will be for products that borrowers are eligible for; and/or (3) lenders offers will be based upon current rates (i.e., lenders must update rates in the systems used to determine initial offers for borrowers within 24 hours of rate sheet changes). The goal of this standard is to ensure that offers are based on current rate data and, therefore, more closely reflect the rates available to borrowers.

Standard #3: Lenders may be required to return offers to the Loan Facilitator system 30 within five minutes 95% of the time. This standard ensures that borrowers quickly receive offers from all matched lenders and in approximately the same time frame.

Standard #4: The interest rate included in the initial offer me be required to be based on an assumed 30-day lock period, inclusion of escrows, and/or no reductions for automatic payments. This standard supports the goal of easing offer comparisons by borrowers.

Standard #5: Lenders offers may not be allowed to include more than three discount points, or points used to “buy down” an interest rate, and/or more than two origination points, or points charged by the lender to cover costs associated with the loan, evaluating, preparing and submitting the loan offer proposals to the borrowers, and/or paying the Loan Officers' commission/fee. This standard supports the goal of easing offer comparisons by borrowers.

Standard #6: For each offer provided, lenders may be required to include one or more of the following fields of information related to fees, loan program, and monthly payment: Loan Program Product Type (e.g. Fixed, ARM, Balloon, etc.), Loan Program Category (FHA, VA, RD, Cony. Ins., Cony. Unins.), Initial ARM Term, Amortization Term, Estimated Monthly Payment for Principle and Interest, Estimated Monthly Payment for MI, Prepayment Penalty (Y/N), Interest Only (Y/N), Interest Only Period, Documentation Type (Full or Limited), Lender Name, Name of Product/Loan Program Offered, Loan Term, Loan Amount, Interest Rate, APR, Down Payment, Origination Points (line 801 of HUD (Department of Housing and Urban Development)), Discount Points (line 802 of HUD), Other Lender Fees (sum of remaining 800 lines of HUD), Loan Officer Name (or Default Contact), Loan Officer Phone Number (or Default Contact), Loan Officer Email Address (Or Default Contact), Welcome Message to Borrower, Offer Description, and Canned Text/Disclosures. In one embodiment, other HUD line items can be included. This standard supports the goal of easing offer comparisons by borrowers.

One goal of these offer enhancements is to ensure that the offers presented to borrowers are personalized. According to embodiments described herein, offers may reflect each borrower's preferences and are the lenders' best estimate (based on the information provided by the borrower) of what a borrower could expect after executing the full application process. These offer enhancements ensure that the offers presented to borrowers are consistent. Lenders will return the same data points to ensure that offers are easy-to-compare by borrowers.

Previously, lenders had unlimited freedom to determine loan program names, which is reflective of traditional industry norms. With the methods and systems provided herein, however, lender's unique program names may be translated into more easily understood, and more easily compared, names. Previously, lenders could optionally include information about their various fees in the offers, which is reflective of industry norms that lenders each have different fee structures. With the methods and systems provided herein, according to one embodiment, lenders may include HUD line items 801, 802, and a lump sum of all other 800 line item fees, thus providing borrowers with at least three consistent data points to compare concerning lender-specific costs associated with the Offers.

After reviewing the offer(s) provided by the one or more matched lenders (e.g., via the website operated by the Loan Facilitator server 32), the borrower can reply stating whether he or she accepts or denies the lender's credit offer. In one embodiment, this may involve the borrower communicating directly with the lender (e.g., transmitting an email or similar message from the borrower's electronic device to the corresponding lender server 40a, b, c), or posting a message on the website operated by the Loan Facilitator server 32, wherein the lender can access and view the message via the website.

If accepted, the lender can then contact the borrower to coordinate the closing of the loan. In one embodiment, the lender has the borrower's name, social security number, application ID number, phone number at both work and home, and the best time to contact the borrower from the acceptance message (e.g., email) sent when the offer was accepted. The loan closing can take place in any way that the lender typically closes loans. Once all documents are signed and delivered from the borrower, the loan is closed. Once the lender closes a loan, the lender can provide the Loan Facilitator system 30 with a notification of the loan closure. This information can be stored by the Loan Facilitator system 30 and accessed by the lenders. In particular, according to one embodiment, information about the transaction can be stored to allow lenders to have access to their lending history.

Another aspect of embodiments described herein is a performance analytics component. In particular, according to one embodiment, the Loan Facilitator system 30 can provide a web-based platform, or portal, configured to support lender and Loan Facilitator system 30 business operations and to facilitate business performance analytics. Using the portal of one embodiment, lenders can view and analyze both current day and historical business performance including, for example, inventory purchases, loan offers provided, closed loans, and/or the like, both in aggregate and by subsets according to various descriptive attributes, such as, credit score, loan amount, matched fee, and/or the like. As used herein, inventory can refer to the pool of borrowers available to be matched with lenders through the Loan Facilitator system 30.

According to embodiments of the present invention, lenders can also use the portal to manage special programs initiated by the Loan Facilitator system 30, such as, Hot Transfer program, Certified Loan Officer program, and/or the like.

In one embodiment, Loan Facilitator system 30 staff (“Internal Users”) can have access to data that staff associated with the various lenders (“External Users”) do not have access to, such as the ability to aggregate data across various groupings of lenders, (e.g. a group of lenders that comprise a specific sales region). All users can be granted a unique User Account and password associated with the portal that will both serve to provide security controls for access to information and to ensure that the information provided is restricted to the data that is relevant to each user.

Various aspects of the performance analytics component can be referred to as “closed feedback loops,” wherein one party provides information that the other party uses to monitor, and revise as necessary, business operations. The data used to support such a loop can be referred to as “closed loop data.”

According to one embodiment, lenders can place orders for inventory through the portal provided by the Loan Facilitator system 30. In particular, the system can provide data about current inventory available for purchase, as well as inventory previously purchased (historical data), within the portal. Lenders can use the provided information to search for additional inventory, update standing orders for inventory, and place additional orders for inventory. According to one embodiment, an order can be a unique set of specified loan values that can be saved as a group.

The Loan Facilitator system 30 can provide additional performance analytics, as described below, that lenders can use to continuously search for, and revise orders for, inventory.

As described above, lenders can provide offers to borrowers, according to Best Offer Strategies and Offer Standards. According to one embodiment, the Loan Facilitator system 30 can make available to lenders, through the portal, the ability to view and compare offers to competing lenders' offers. Lenders can view and compare competing lenders' (“competitors”) offers data for both specific borrowers and various aggregated levels for both current day and previous time periods. Lenders can use this feedback to evaluate their competitiveness and revise both their orders and their Best Offer Strategies as necessary.

In addition, for each loan closed as a result of operations with the Loan Facilitator system 30, according to one embodiment, lenders can be contractually bound to provide details about the closed loan back to the system. Lenders can provide this information through the portal. Once this information is received, the Loan Facilitator system 30 can provide the ability for lenders to perform analytics upon this data. In particular, lenders can view closed loan data at both specific borrower and various aggregated levels across various time periods. Lenders can use this feedback to, for example, revise standing inventory orders, search for additional inventory, place orders for additional inventory, revise Best Offer Strategies, and/or the like.

In one embodiment, the Loan Facilitator system 30 can provide analytic tools to assist lenders in analyzing performance of special programs, such as Hot Transfer and Certified Loan Officer programs. This information can be in the form of a feedback loop, wherein the Loan Facilitator system 30 can provide the ability for lenders to participate in such programs, lenders can monitor performance through tools provided by the portal, and/or lenders can make adjustments based on the analytical results.

According to another embodiment, borrowers that close loans with lenders through the system can provide feedback about their experience with lenders. The Loan Facilitator system 30 can make available to lenders, through the portal, the ability to view this feedback. Lenders can utilize this information to improve the effectiveness of their operations with the Loan Facilitator system 30 and borrowers.

In one embodiment, lenders can view both individual business scores, such as Matched Count Rank, Closed Loan Count Rank, and Offer Response Time Rank, as well as an aggregated score that will be a weighted average of these individual scores.

In another embodiment, lenders can use the portal to register and manage other aspects of their relationship with the Loan Facilitator system 30. For example, the ability to download documents such as contracts and schedule of fees, the ability to electronically sign documents such as contracts, the ability to pay registration fees, and/or the like.

In yet another embodiment, invoices can be presented in the portal for lenders to view and download. Lenders can also provide payments on invoices through the portal.

The Loan Facilitator system 30 of one embodiment can further provide various support services to lenders through the portal, such as viewable and downloadable White Papers & Best Practices materials, video and sound recordings, online chat, and submission of support requests. The Loan Facilitator system 30 can utilize various components of the closed loop performance analytics data to refine the proprietary logic used to match borrowers to lenders.

### CONCLUSION

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

That which is claimed:

1. A method comprising:
receiving a credit application associated with a borrower;
retrieving, from a database, a set of selection criteria associated with each of a plurality of lenders;
comparing, by a computing device executing a matching module, the credit application received to the plurality of sets of selection criteria in order to identify one or more matched lenders;
transmitting the credit application to at least one of the one or more matched lenders; and
receiving, by the computing device from the at least one of the one or more matched lenders, one or more offers to provide to the borrower in association with the at least one matched lender, wherein the one or more offers were identified by applying a set of business rules associated with the at least one matched lender to the credit application.

2. The method of claim 1, wherein the set of business rules associated with the matched lender defines one or more offers to provide to the borrower based at least in part on a potential profit margin for the matched lender associated with respective offers.

3. The method of claim 2, wherein the set of business rules associated with the matched lender further defines one or more offers to provide to the borrower based at least in part on an eligibility and probability of payment associated with the borrower.

4. The method of claim 1 further comprising:
providing, by the computing device, a web-based platform through which respective lenders of the plurality of lenders can view information associated with one or more offers made and one or more offers accepted in association with the corresponding lender.

5. The method of claim 4, wherein respective lenders of the plurality of lenders can further view information associated with one or more offers made and one or more offers accepted in association with other lenders of the plurality of lenders via the web-based platform.

6. The method of claim 5, wherein at least one of the plurality of lenders modifies one or more business rules of the set of business rules associated with the at least one lender based at least in part on information viewed via the web-based platform.

7. The method of claim 5 further comprising:
enabling respective lenders of the plurality of lenders to filter the information viewable via the web-based platform based on one or more attributes.

8. The method of claim 7, wherein the one or more attributes are selected from a group consisting of a borrower, a credit score, a loan amount, and a matched fee.

9. The method of claim 1 further comprising:
aggregating, by the computing device, the one or more offers received in a standardized format; and
presenting the aggregated and standardized offers to the borrower.

10. The method of claim 8, wherein receiving a credit application comprises receiving the credit application via a website, and wherein presenting the aggregated and standardized offers further comprises displaying the aggregated and standardized offers on the website.

11. The method of claim 1, wherein the credit application received comprises a plurality of credit data elements and wherein respective sets of selection criteria define a matching value for one or more of the plurality of credit data elements, such that comparing the received credit application to respective sets of selection criteria further comprises determining whether the value of one or more credit data elements of the credit application received match the matched value of the corresponding one or more data elements defined by the set of selection criteria.

12. A computer program product comprising at least one computer-readable storage medium having computer-readable program code portions stored therein, said computer-readable program code portions comprising:
a first executable portion for receiving a credit application associated with a borrower;
a second executable portion for retrieving, from a database, a set of selection criteria associated with each of a plurality of lenders;
a third executable portion for comparing the credit application received to the plurality of sets of selection criteria in order to identify one or more matched lenders;
a fourth executable portion for transmitting the credit application to at least one of the one or more matched lenders; and
a fifth executable portion for receiving, from the at least one of the one or more matched lenders, one or more offers to provide to the borrower in association with the at least one matched lender, wherein the one or more offers were identified by applying a set of business rules associated with the at least one matched lender to the credit application.

13. The computer program product of claim 12, wherein the set of business rules associated with the matched lender defines one or more offers to provide to the borrower based at least in part on a potential profit margin for the matched lender associated with respective offers.

14. The computer program product of claim 13, wherein the set of business rules associated with the matched lender further defines one or more offers to provide to the borrower based at least in part on an eligibility and probability of payment associated with the borrower.

15. The computer program product of claim 12 further comprising:
a sixth executable portion for providing a web-based platform through which respective lenders of the plurality of lenders can view information associated with one or more offers made and one or more offers accepted in association with the corresponding lender and with other lenders of the plurality of lenders.

16. The computer program product of claim 15, wherein at least one of the plurality of lenders modifies one or more business rules of the set of business rules associated with the at least one lender based at least in part on information viewed via the web-based platform.

17. The computer program product of claim 12 further comprising:
a sixth executable portion for aggregating the one or more offers received in a standardized format; and
a seventh executable portion for presenting the aggregated and standardized offers to the borrower.

18. A network device comprising:
a processor configured to:
receive a credit application associated with a borrower;
retrieve, from a database, a set of selection criteria associated with each of a plurality of lenders;
compare the credit application received to the plurality of sets of selection criteria in order to identify one or more matched lenders;
transmit the credit application to at least one of the one or more matched lenders; and
receive, from the at least one of the one or more matched lenders, one or more offers to provide to the borrower in association with the at least one matched lender, wherein the one or more offers were identified by applying a set of business rules associated with the at least one matched lender to the credit application.

19. The network device of claim 18, wherein the processor is further configured to:
provide a web-based platform through which respective lenders of the plurality of lenders can view information associated with one or more offers made and one or more offers accepted in association with the corresponding lender and with other lenders of the plurality of lenders.

20. The network device of claim 18, wherein the processor is further configured to:
aggregate the one or more offers received in a standardized format; and
present the aggregated and standardized offers to the borrower.
